(19) United States
(12) Patent Application Publication
(10) Pub. No.: US 2001/0020952 A1
(43) Pub. Date: Sep. 13, 2001

(54) Script producing apparatus and script producing program storage medium

(76) Inventor: Taiji Iwasaki, Kanagawa (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/793,989

(22) Filed: Feb. 28, 2001

(30) Foreign Application Priority Data
Feb. 29, 2000 (JP) 2000-053875

(51) Int. Cl. G06F 3/00

(52) U.S. Cl. 345/704; 345/763

(57) ABSTRACT

A script producing apparatus has an execution diagram producing section having a plurality of GUIs including both a turn GUI for displaying a predetermined turn symbol on an image display screen in accordance with an operation, said turn symbol indicating that a plurality of processes are sequentially executed, and also indicating turn of execution for the processes, and a parallel GUI for displaying a parallel symbol on said image display screen in accordance with an operation, said parallel symbol indicating that a plurality of processes are simultaneously executed, and a script producing section for producing, upon receipt of production of the execution diagram by said execution diagram producing section, a script representative of an execution order identical with the execution order represented by the execution diagram produced by said execution diagram producing section, wherein the execution order of the script is able to be recognized by a processing unit for executing a process.

### BACKGROUND OF THE INVENTION

1. Field of the Invention

The present invention relates to a script producing apparatus for producing a script representative of an execution order of a plurality of processes, and a script producing program storage medium storing a script producing program which causes a computer system to operate as such a script producing apparatus when the script producing program is executed in the computer system.

2. Description of the Related Art

Hitherto, there is known an image processing apparatus in which various sorts of image processing are applied to image data representative of an original image to produce image data representative of a desired image. Particularly, in the field of prints and the like, there is needed a high definition of original image. For this reason, it is necessary to provide a large data size of original image, and also it is necessary for the image processing apparatus to perform a lot of computations for the image processing. In view of the foregoing, there is developed an image processing apparatus having a plurality of CPUs in which an image processing is carried out on a share basis by the CPUs to contribute to a higher speed of image processing.

By the way, in case of developing such an image processing apparatus having a plurality of CPUs, there is a need to design an execution order so that the image processing is executed by the plurality of CPUs on a share basis to produce a desired image data, and cause the image processing apparatus to execute the image processing in the execution order thus designed.

Thus, it is considered that a script, in which the designed execution order is represented by a format (for example, a text format and an execution format, etc.) capable of being recognized by the image processing apparatus, is produced, and the script thus produced is incorporated into the image processing apparatus so that the image processing apparatus executes the image processing in the execution order represented by the script to produce a desired image data.

However, a script, the format of which the image processing apparatus can recognize, is hard for a person to be understood. Particularly, in the execution order in which processing is executed on a share basis by a plurality of CPUs, there are mixed an execution order in which processes are simultaneously carried out, and an execution order in which processes are sequentially carried out, and thus it is very difficult to grasp the execution order in its entirety. Further, there is a high possibility that a bug occurs owing to an erroneous input or the like.

Such a problem is not restricted to the fields of the printing and the image processing, and is generally associated with a case of producing the script representative of the execution order in which an execution order in which processes are simultaneously carried out, and an execution order in which processes are sequentially carried out are mixed.

### SUMMARY OF THE INVENTION

In view of the foregoing, it is an object of the present invention to provide a script producing apparatus capable of producing a script while the execution order is easily grasped, and a script producing program storage medium storing a script producing program which causes a computer system to operate as such a script producing apparatus when the script producing program is executed in the computer system.

To achieve the above-mentioned object, the present invention provides a script producing apparatus comprising:

an execution diagram producing section having a plurality of GUIs including both a turn GUI for displaying a predetermined turn symbol on an image display screen in accordance with an operation, said turn symbol indicating that a plurality of processes are sequentially executed, and also indicating turn of execution for the processes, and a parallel GUI for displaying a parallel symbol on said image display screen in accordance with an operation, said parallel symbol indicating that a plurality of processes are simultaneously executed, said execution diagram producing section producing an execution diagram representative of an execution order permitting a simultaneous execution for a plurality of processes in accordance with the plurality of GUIs; and

a script producing section for producing, upon receipt of production of the execution diagram by said execution diagram producing section, a script representative of an execution order identical with the execution order represented by the execution diagram produced by said execution diagram producing section, wherein the execution order of the script is able to be recognized by a processing unit for executing a process.

According to the script producing apparatus of the present invention as mentioned above, the execution diagram producing section produces an execution diagram representative of an execution order in accordance with the plurality of GUIs, and the script producing section translates the execution diagram into a script. Thus, when a designer designs an execution order in form of a diagram which is easy to be grasped in the execution order, the script is automatically produced.

The script producing apparatus of the present invention is particularly effective when it is applied to fields of an image processing and a print. In the script producing apparatus applied to such fields, the execution diagram producing section produces an execution diagram representative of an execution order for a plurality of image processes in accordance with the plurality of GUIs, and

the script producing section produces, as said scrip, a script wherein the execution order of the script is able to be recognized by an image processing unit for executing an image process.

In the script producing apparatus according to the present invention as mentioned above, it is preferable that said execution diagram producing section produces an execution diagram representative of an execution order for a plurality of data processes, and

said plurality of GUIs includes both said turn GUI and said parallel GUI, and in addition a data transfer GUI for displaying a data transfer symbol on said image display screen in accordance with an operation, said data transfer symbol indicating a data transfer between a memory for storing data and a data processing.

In the script producing apparatus according to the present invention as mentioned above, it is preferable that said plurality of GUIs includes both said turn GUI and said parallel GUI, and in addition a branch GUI for displaying a branch symbol on said image display screen in accordance with an operation, said branch symbol indicating that an execution order for a process branches.

According to the script producing apparatus having the data transfer GUI and the branch GUI as mentioned above, it is possible to readily design details of the execution order.

To achieve the above-mentioned object, the present invention provides a script producing program storage medium storing a script producing program comprising:

execution diagram producing means having a plurality of GUIs including both a turn GUI for displaying a predetermined turn symbol on an image display screen in accordance with an operation, said turn symbol indicating that a plurality of processes are sequentially executed, and also indicating turn of execution for the processes, and a parallel GUI for displaying a parallel symbol on said image display screen in accordance with an operation, said parallel symbol indicating that a plurality of processes are simultaneously executed, said execution diagram producing section producing an execution diagram representative of an execution order permitting a simultaneous execution for a plurality of processes in accordance with the plurality of GUIs; and

script producing means for producing, upon receipt of production of the execution diagram by said execution diagram producing means, a script representative of an execution order identical with the execution order represented by the execution diagram produced by said execution diagram producing means, wherein the execution order of the script is able to be recognized by a processing unit for executing a process.

Said execution diagram producing section and said script producing section, which constitute said script producing apparatus, correspond to said execution diagram producing means and said script producing means, which constitute said script producing program, respectively. The execution diagram producing section and the script producing section indicate a coupling of the software with the hardware for their associated effect. On the other hand, the execution diagram producing means and the script producing means indicate only a software portion for their associated effect.

With respect to the script producing program, there is shown simply a basic form as mentioned above. But the script producing program of the present invention is not restricted to such a basic form of script producing program, and includes a various forms of script producing program corresponding to those of the script producing apparatus.

### BRIEF DESCRIPTION OF THE DRAWINGS

FIG. 1 is a schematic constitution view of a printing image and proof image producing system to which an embodiment of the present invention is applied.

FIG. 2 is a perspective view of a proofer.

FIG. 3 is a hardware structural view of the personal computer.

FIG. 4 is a view showing an example of an execution diagram produced by an execution diagram producing tool.

FIG. 5 is a view showing an execution diagram producing tool.

FIG. 6 is a flowchart useful for understanding a producing procedure of a script.

FIG. 7 is a view showing an embodiment of a script producing program storage medium according to the present invention.

### DETAILED DESCRIPTION OF PREFERRED EMBODIMENTS

Embodiments of the present invention will be described with reference to the accompanying drawings.

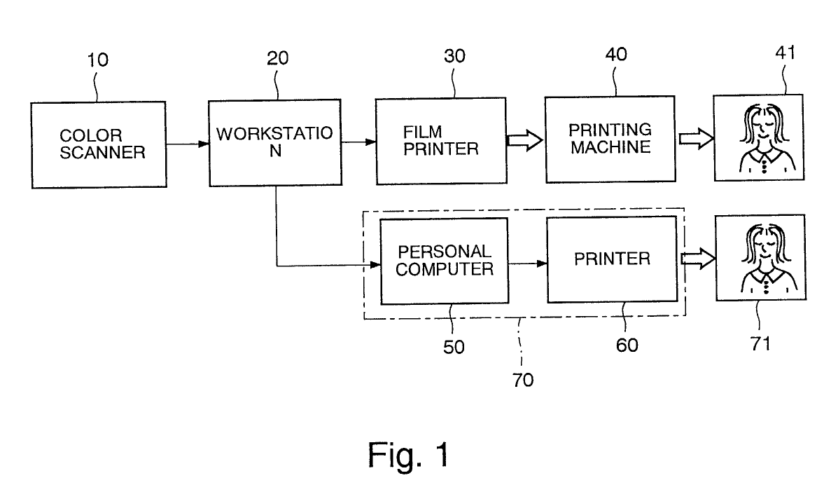

FIG. 1 is a schematic constitution view of a printing image and proof image producing system to which an embodiment of the present invention is applied.

A color scanner 10 reads an original image and produces color separation image data for CMYK four colors representative of the original image thus read. The image data for CMYK four colors is fed to a workstation 20. In the workstation 20, an operator performs an electronic page make-up in accordance with the fed image data to generate image data representative of an image for printing. The image data for printing represents an image consisting of pixels having gradation on each of the CMYK four colors. In the event that a printing is performed, the image data for printing is converted into image data for plate making representative of an image consisting of halftone dots and then fed to an image film printer 30 to produce a printing film original plate consisting of plates for CMYK associated with the image data for plate making.

A printing plate is produced from the printing film original plate, and then mounted on a printing machine 40. Ink is applied to the printing plate mounted on the printing machine 40. The ink thus applied is transferred to a printing paper so that a printed image 41 is formed on the printing paper.

Such a series of work that a film original plate is produced by the film printer 30, a printing plate is produced and mounted on the printing machine 40, and ink is applied to the printing plate mounted on the printing machine 40 to perform a printing on a paper, is large projects and also takes a lot of cost. For this reason, before the actual printing work is performed, a proofer 70, which comprises a personal computer 50 and a printer 60, is used to produce a proof image 71 in the manner as set forth below to confirm a finish of the printed image 41 beforehand.

To produce the proof image 71, image data for printing, which is produced by the electronic page make-up on the workstation 20, is fed to the personal computer 50. The personal computer 50 applies various sorts of image processing to the image data for printing so that the image data for printing is converted into proof image data for RGB three colors suitable for the printer 60 now intending to output the proof image 71. The personal computer 50 is provided with a plurality of CPUs which perform a various sorts of image processing on a share basis. The printer 60 receives the proof image data for RGB three colors obtained by the image processing and produces the proof image 71 in accordance with the received proof image data for RGB three colors.

The proofer 70 receives printing image data from the workstation 20 via the computer network, or by an MO disk (a magneto-optical disk).

The personal computer 50 serves also as an embodiment of the script producing apparatus of the present invention, and produces and stores beforehand a script representative of the execution order for the image processing to be executed on a share basis by the plurality of CPUs. When the proof image 71 is produced, the image processing is carried out in accordance with the script.

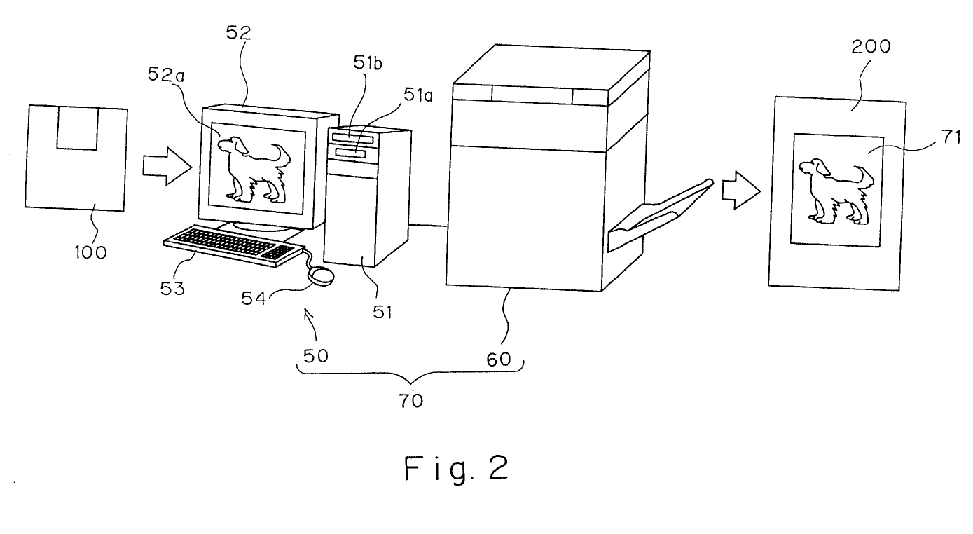

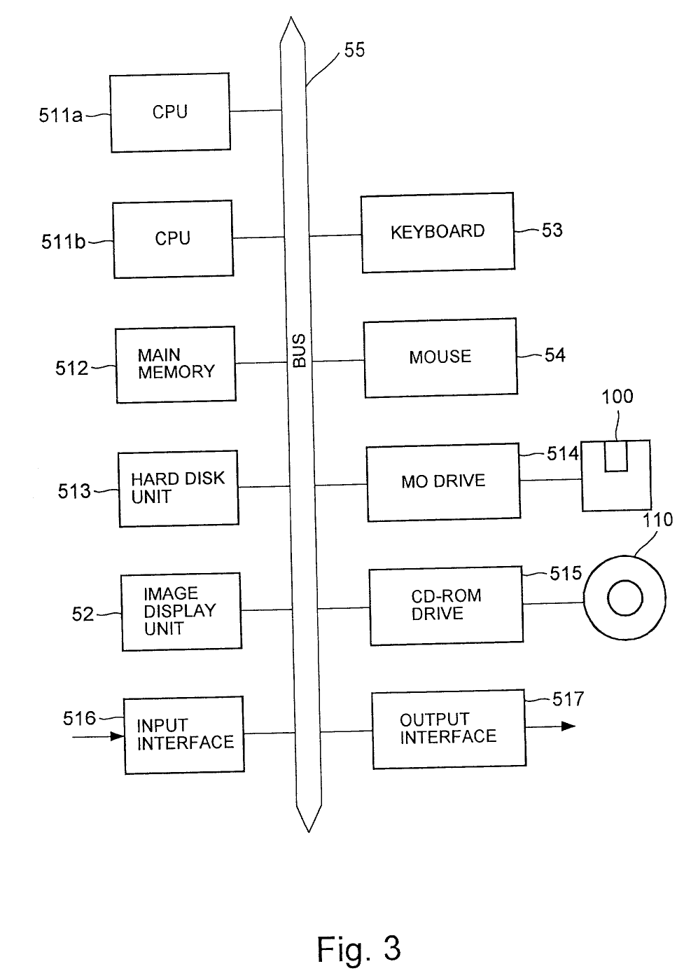

FIG. 2 is a perspective view of the proofer 70. FIG. 3 is a hardware structural view of the personal computer 50.

As mentioned above, the proofer 70 comprises the personal computer 50 and the printer 60. The personal computer 50 comprises, on an external appearance, a main frame unit 51, an image display unit 52 for displaying an image on a display screen 52a in accordance with an instruction from the main frame unit 51, a keyboard 53 for inputting various sorts of information to the main frame unit 51 in accordance with a key operation, and a mouse 54 for inputting an instruction according to, for example, an icon and the like, through designation of an optional position on the display screen 52a, the icon and the like being displayed on the position on the display screen 52a. The main frame unit 51 has a floppy disk mounting slot 51a for mounting a floppy disk, and a CD-ROM mounting slot 51b for mounting a CD-ROM.

The printer 60 is a high definition printer for a proof image output, which receives image data from the personal computer 50 and outputs the proof image 71 on a sheet 200 in accordance with an instruction from the personal computer 50.

The main frame unit 51 comprises, as shown in FIG. 3, two CPU 511a and CPU 511b for executing a various types of program, a main memory 512 in which a program stored in a hard disk unit 513 is read out and developed for execution by the CPU 511a and the CPU 511b, the hard disk unit 513 for saving various types of programs and data, an MO drive 514 for accessing an MO disk 100 mounted thereon, a CD-ROM drive 515 for accessing a CD-ROM 110 mounted thereon, an input interface 516 connected to the workstation 20 (cf. FIG. 1), to receive image data from the workstation 20, and an output interface 517 to transmit image data to the printer 60. These various types of elements are connected via a bus 55 to the image display unit 52, the keyboard 53 and the mouse 54.

In the event that the personal computer 50 is operated as a part of the proofer 70, the image processing is carried out on a share basis by the two CPU 511a and CPU 511b of the main frame unit 51. In the event that the personal computer 50 is operated as the script producing apparatus of the present invention, the program is carried out by the CPU 511a only.

The CD-ROM 110 stores therein a script producing program for causing the personal computer 50 to operate as a script producing apparatus. The CD-ROM 110 is mounted on the CD-ROM drive 515 so that the script producing program, which is stored in the CD-ROM 110, is up-loaded on the personal computer 50 and is stored in the hard disk unit 513.

When the CD-ROM 110 stores therein an embodiment of the script producing program of the present invention, the CD-ROM 110 corresponds to the embodiment of the script producing program storage medium of the present invention. When the script producing program is up-loaded and stored in the hard disk unit 513, the hard disk unit 513, which is in a state that the script producing program is stored in the hard disk unit 513, also corresponds to the embodiment of the script producing program storage medium of the present invention. Further, in the event that the script producing program is down-loaded onto a floppy disk and the MO disk 100, the floppy disk and the MO disk 100, which are in a state that the script producing program is stored in therein, also correspond to the embodiment of the script producing program storage medium of the present invention.

Hereinafter, there will be described an operation as the script producing apparatus of the present invention in the personal computer 50.

In the event that the personal computer 50 operates as the script producing apparatus, an execution diagram producing tool, which will be described later, is displayed on the display screen 52a of the display unit 52 shown in FIG. 2, so that an execution diagram representative of the execution order for processing is produced on the display screen 52a in accordance with the operation of the mouse 54. In other words, the display unit 52 and the mouse 54 constitute an example of the execution diagram producing section referred to in the present invention.

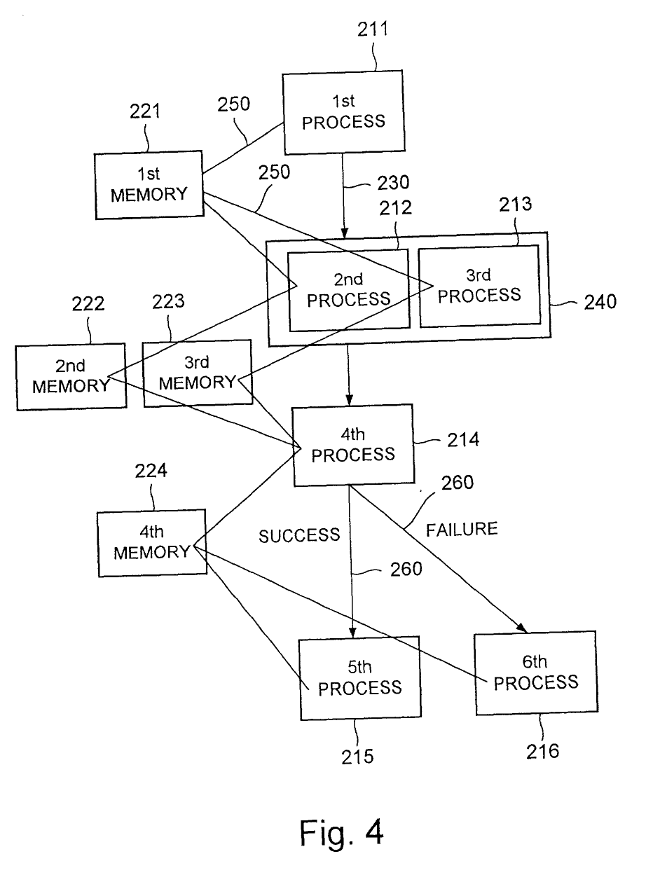

FIG. 4 is a view showing an example of an execution diagram produced by an execution diagram producing tool.

The execution diagram represents the execution order as will be described hereinafter.

First, a first processing 211 is executed so that image data representative of a processing result is stored in a first memory 221.

Next, a second processing 212 and a third processing 213 are simultaneously performed. In the second processing 212, the image data stored in the first memory 221 is read to be subjected to the image processing, so that image data representative of a processing result is stored in a second memory 222. On the other hand, in the third processing 213, the image data stored in the first memory 221 is read to be subjected to the image processing, so that image data representative of a processing result is stored in a third memory 223.

Next, a fourth processing 214 is carried out. In the fourth processing 214, the image data stored in the second memory 222 and the image data stored in the third memory 223 are read to be subjected to the image processing, so that image data representative of a processing result is stored in a fourth memory 224.

Thereafter, with respect to the processing result of the fourth processing 214, it is determined as to whether the processing is of “success” or “failure” in accordance with a predetermined criterion. In the event that it is decided that the processing is of “success”, the image data stored in the fourth memory 224 is read to be subjected to a fifth image processing 215. In the event that it is decided that the processing is of “failure”, the image data stored in the fourth memory 224 is read to be subjected to a sixth image processing 216.

According to the execution diagram as mentioned above, it is extremely easy to grasp the execution order for the processing.

In the execution diagram shown in FIG. 4, turn of the processing to be executed in turn is shown by an arrow 230. Further, it is shown with a box 240 including a plurality of processes that the plurality of processes are simultaneously carried out. The arrow 230 is an example of the turn symbol referred to in the present invention. The box 240 is an example of the parallel symbol referred to in the present invention.

According to the execution diagram of FIG. 4, data transfers between the processes and the memories are indicated by lines 250 coupling the processes and the memories. The line 250 is an example of the data transfer symbol referred to in the present invention.

Further, according to the execution diagram of FIG. 4, it is indicated by a two-way arrow 260 that the execution order of the processes branches. The two-way arrow 260 is an example of the branch symbol referred to in the present invention.

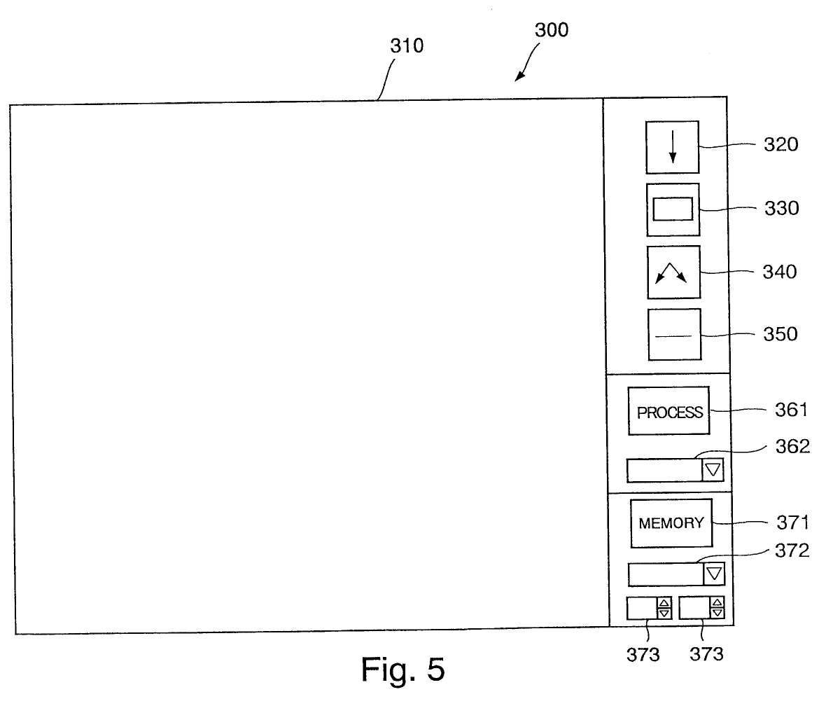

FIG. 5 is a view showing an execution diagram producing tool.

An execution diagram producing tool 300 is provided with an arrow button 320 for selecting a function of drawing the arrow 230 shown in FIG. 4. When the arrow button 320 is clicked, the execution diagram producing tool 300 serves as the turn GUI referred to in the present invention and draws the arrow 230 in an execution diagram producing column 310 in accordance with the mouse operation. The execution diagram producing tool 300 is further provided with a box button 330 for selecting a function of drawing the box 240 shown in FIG. 4. When the box button 330 is clicked, the execution diagram producing tool 300 serves as the parallel GUI referred to in the present invention and draws the box 240 in an execution diagram producing column 310 in accordance with the mouse operation.

In this manner, the execution diagram producing tool 300 serves as the turn GUI and the parallel GUI referred to in the present invention. Thus, according to the present embodiment of the present invention, it is possible to easily produce the execution diagram representative of the execution order in which the sequential execution and the simultaneous execution are mixed.

The execution diagram producing tool 300 is furthermore provided with a branch button 340 for selecting a function of drawing the two-way arrow shown in FIG. 4. When the branch button 340 is clicked, the execution diagram producing tool 300 serves as the branch GUI referred to in the present invention and draws the two-way arrow in an execution diagram producing column 310 in accordance with the mouse operation.

The execution diagram producing tool 300 is still further provided with a line button 350 for selecting a function of drawing the line shown in FIG. 4. When the line button 350 is clicked, the execution diagram producing tool 300 serves as the data transfer GUI referred to in the present invention and draws the two-way arrow in an execution diagram producing column 310 in accordance with the mouse operation.

The execution diagram producing tool 300 is still furthermore provided with a processing mark button 361 and a memory mark button 371. When the processing mark button 361 is clicked, a processing mark representative of a processing of a sort selected by a processing sort selection box 362 is displayed on the execution diagram producing column 310. When the memory mark button 371 is clicked, a memory mark representative of a memory area selected by a memory area selection box 372 or determined in its limit by memory area editing boxes 373 is displayed on the execution diagram producing column 310. Those processing mark and the memory mark are disposed on the execution diagram producing column 310 by drag and drop.

As the execution diagram producing tool 300 draws the execution diagram in accordance with the mouse operation, the main frame 51 shown in FIG. 2 produces a script in accordance with a procedure which will be described hereinafter. That is, the main frame 51 is an example of an script producing section referred to in the present invention.

Hereinafter, there will be described a procedure of producing a script.

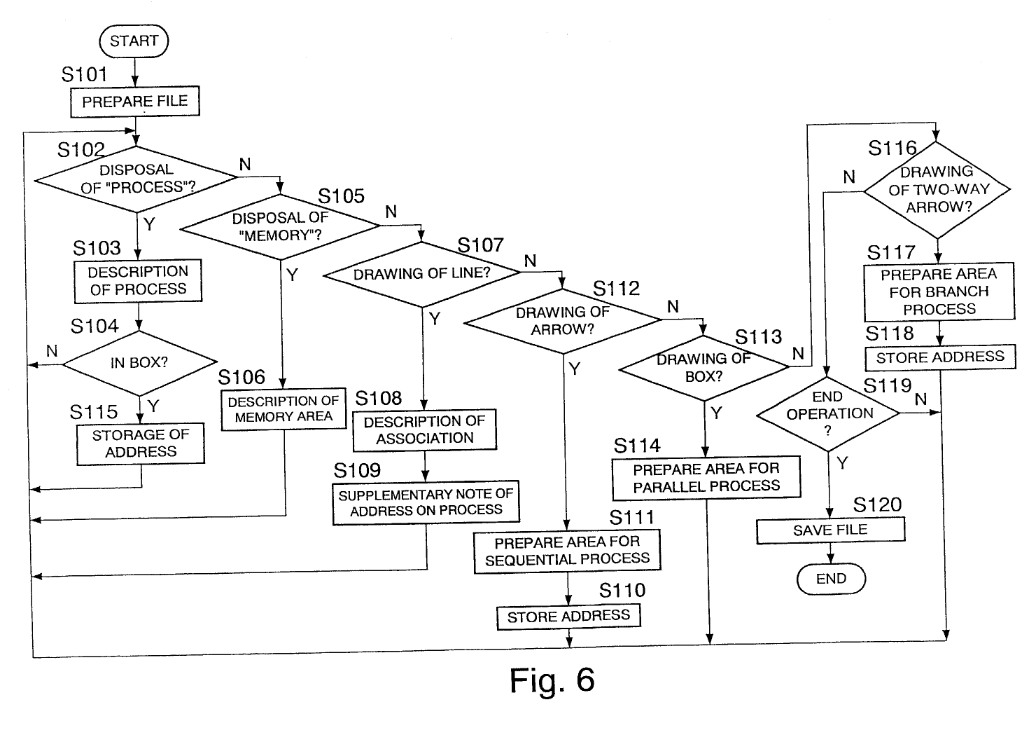

FIG. 6 is a flowchart useful for understanding a procedure of producing a script. A table 1 shows a script corresponding to the execution diagram shown in FIG. 4.

TABLE 1

| Address | Description | Supplementary Note |
|---|---|---|
| 001 | First processing | 015 |
| 002 | First memory | |
| 003 | Second processing | 016 018 |
| 004 | Third processing | 017 019 |
| 005 | Second memory | |
| 006 | Third memory | |
| 007 | Fourth processing | 020 021 022 |
| 008 | Fourth memory | |
| 009 | Fifth processing | 023 |
| 010 | Sixth processing | 024 |
| : | | |
| 015 | [001] is associated with [002] | |
| 016 | [002] is associated with [003] | |
| 017 | [002] is associated with [004] | |
| 018 | [003] is associated with [005] | |
| 019 | [004] is associated with [006] | |
| 020 | [005] is associated with [007] | |
| 021 | [006] is associated with [007] | |
| 022 | [007] is associated with [008] | |
| 023 | [008] is associated with [009] | |
| 024 | [008] is associated with [010] | |
| : | | |
| 030 | parallel processing | 032 |
| 031 | 003 | |
| 032 | 004 | |
| 033 | | |
| 034 | | |
| 035 | | |
| : | | |
| 040 | sequential processing | 044 |
| 041 | 001 | |
| 042 | 030 | |
| 043 | 007 | |
| 044 | 050 | |
| 045 | | |
| : | | |
| 050 | branch processing | 052 |
| 051 | 009 | |
| 052 | 010 | |
| 053 | | |

when the execution diagram producing tool 300 shown in FIG. 5 is displayed, the producing procedure represented by the flowchart of FIG. 6 is initiated. First, a file for a script is prepared (step S101). In the file, a series of addresses as shown in the address column of Table 1 and the associated description areas and supplementary areas are prepared.

Next, in step S102, it is decided whether the processing mark is disposed on the execution diagram producing column 310. When it is decided that the processing mark is disposed on the execution diagram producing column 310, a description representative of a processing sort corresponding to the disposed processing mark is stored in the description area prepared in the file for the script (step S103). For example, a description column for the address “001,” of Table 1 stores therein a description representative of a processing sort such as a “first processing”. Here, it is acceptable that the description representative of a processing sort is a name of a program representative of processing contents of the processing sort, or alternatively the program it self.

Thereafter, it is decided whether the processing mark disposed on the execution diagram producing column 310 is disposed within the box representative of the simultaneous parallel processing (step S104). When it is decided that the processing mark is disposed out of the box, the process returns to the step S102.

In the step S102, when it is decided that the processing mark is disposed, it is determined whether the memory mark is disposed on the execution diagram producing column 310 (step S105). When it is decided that the memory mark is disposed, a description (for example, a value of a memory address) representative of a memory area corresponding to the disposed memory mark is stored in the description area (step S106). For example, a description column for the address “002” of Table 1 stores therein a description representative of a memory area used as a “first memory”. Thereafter, the process returns to the step S102.

In the step S105, when it is decided that the memory mark is not disposed, it is determined whether a line representative of a data transfer between the processing and the memory is drawn (step S107). When it is decided that the line is drawn, a description indicating that the processing and the memory coupled with each other by the line are associated with one another is stored in the description area (step S108). For example, a description column for the address “015” of Table 1 stores therein a description indicating that a processing represented by the description of the address “001” is associated with a memory represented by the description of the address “002”. Thereafter, a numerical value representative of the address (for example, the address “015” of Table 1) storing the description indicative of the association is stored in the supplementary note area of the address (for example, the address “001” of Table 1) storing the description of the processing coupled with the memory by the line (step S109). Thereafter, the process returns to the step S102.

In the step S107, when it is decided that the line representative of the data transfer is not drawn, it is determined whether an arrow indicative of turn of the processing is drawn (step S110). When it is decided that the arrow is drawn, an address area representative of a list of processes to be sequentially executed is prepared in a file for a script (step S111). Addresses associated with the processes coupled by the arrow are stored in turn in the prepared address area (step S112). For example, a description column for the address “040” of Table 1 stores therein a description indicating that the processes, which are indicated by addresses after the address “040” in form of a list, are sequentially executed, and the last address “044” of the list is shown in the supplementary note area. In the list, there are indicated numerical values “001”, “030”, “007”, “050” for addresses associated with the processes to be sequentially executed. The address shown in the supplementary note column for address “040” is rewritten into a larger address as the processes to be sequentially executed are increased in accordance with the advance of drawing of the execution diagram. After the addresses associated with the processing coupled by the arrow are stored, the process returns to the step S102.

In the step S110, when it is decided that the arrow is not drawn, it is determined whether a box representing that the processing is simultaneously executed is drawn (step S113). When it is decided that the box is drawn, an address area representative of a list of processes to be simultaneously executed is prepared in a file for a script (step S114). For example, a description column for the address “030” of Table 1 stores therein a description indicating that a series of processes, which are indicated by addresses after the address “030” in form of a list, are simultaneously executed, and the last address “032” of the list is shown in the supplementary note area. The address shown in the supplementary note column for address “032” is rewritten into a larger address as the processes to be simultaneously executed are increased in accordance with the advance of drawing of the execution diagram. In this manner, after the address areas representative of the processes to be simultaneously executed are prepared, the process returns to the step S102.

In the event that the above-mentioned processing mark is disposed in the box representing that the processing is simultaneously executed (step S102: Y, step S104: Y), the address associated with the processing represented by the processing mark is stored in the address area prepared in the step S114 (step S115), and the process returns to the step S102.

In the step S113, when it is decided that the box is not drawn, it is determined whether a two-way arrow representing that the execution order of the processing branches is drawn (step S116). When it is decided that the two-way arrow is drawn, an address area representative of a list of processes to be executed after the branch is prepared (step S117). Addresses associated with the processes to be executed after the branch are stored in the prepared address area (step S118). For example, a description column for the address “050” of Table 1 stores therein a description indicating that two processes, which are indicated by addresses after the address “050” in form of a list, are branch destinations, and the last address “052” of the list is shown in the supplementary note area. In the description column associated with the address “051”, there is shown the address “009” as the processing for the branch destination at the time of success. In the description column associated with the address “052”, there is shown the address “010” as the processing for the branch destination at the time of failure. After the address associated with the processing to be executed after the branch is stored, the process returns to the step S102.

In the step S116, when it is decided that the two-way arrow is not drawn, it is determined whether the termination operation for closing the execution diagram producing tool 300 is performed (step S119). When it is decided that the termination operation is performed, the file for the script is saved and terminated (step S120). Thus, the script is completed. In the step S119, when it is decided that termination operation is not performed, the process returns to the step S102.

In this manner, there is produced a script representative of the execution order which is the same as that represented by the execution diagram. The script thus produced is read by the personal computer 50 which is serves as a part of the proofer 70 shown in FIG. 2, so that the image processing is carried out in the execution order represented by the script to produce the proof image 71.

Next, there will be described an embodiment of a script producing program storage medium according to the present invention.

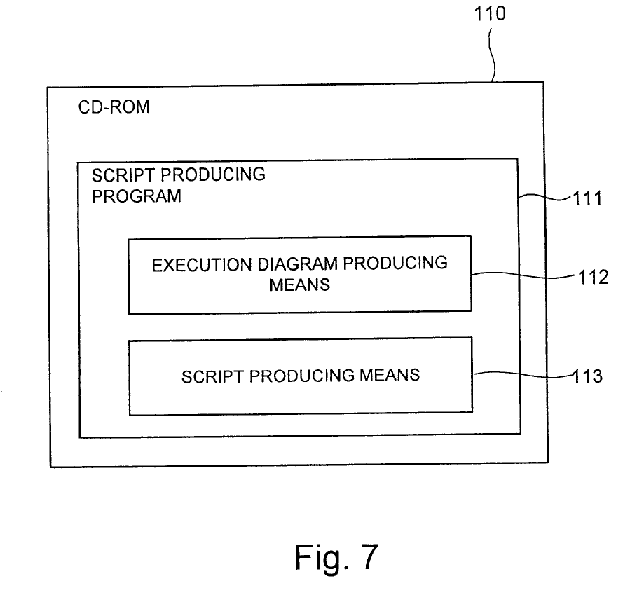

FIG. 7 is a view showing an embodiment of a script producing program storage medium according to the present invention.

As an embodiment of a script producing program storage medium according to the present invention, there is shown the CD-ROM 110 which stores a script producing program 111. The script producing program 111 comprises execution diagram producing means 112 and script producing means 113.

The execution diagram producing means 112 causes the execution diagram producing tool shown in FIG. 5 to be displayed on the display screen 52a of the image display unit 52 shown in FIG. 2 and causes the image display unit 52 and the mouse 54 to operate as an example of the execution diagram producing section referred to in the present invention.

The script producing means 113 produces a script in accordance with the producing procedure shown in FIG. 6, and causes the main frame unit 51 to operate as an example of the script producing section referred to in the present invention.

When the CD-ROM 110 is mounted on the personal computer 50 shown in FIG. 2 so that the script producing program 111 is up loaded, the personal computer 50 serves as an embodiment of the script producing section referred to in the present invention.

As mentioned above, according to the present invention, it is possible to produce a script while easily grasping the execution order.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A script producing apparatus comprising:
an execution diagram producing section having a plurality of GUIs including both a turn GUI for displaying a predetermined turn symbol on an image display screen in accordance with an operation, said turn symbol indicating that a plurality of processes are sequentially executed, and also indicating turn of execution for the processes, and a parallel GUI for displaying a parallel symbol on said image display screen in accordance with an operation, said parallel symbol indicating that a plurality of processes are simultaneously executed, said execution diagram producing section producing an execution diagram representative of an execution order permitting a simultaneous execution for a plurality of processes in accordance with the plurality of GUIs; and
a script producing section for producing, upon receipt of production of the execution diagram by said execution diagram producing section, a script representative of an execution order identical with the execution order represented by the execution diagram produced by said execution diagram producing section, wherein the execution order of the script is able to be recognized by a processing unit for executing a process.

2. A script producing apparatus according to claim 1, wherein said execution diagram producing section produces an execution diagram representative of an execution order for a plurality of image processes in accordance with the plurality of GUIs, and
said script producing section produces, as said scrip, a script wherein the execution order of the script is able to be recognized by an image processing unit for executing an image process.

3. A script producing apparatus according to claim 1, wherein said execution diagram producing section produces an execution diagram representative of an execution order for a plurality of data processes, and
said plurality of GUIs includes both said turn GUI and said parallel GUI, and in addition a data transfer GUI for displaying a data transfer symbol on said image display screen in accordance with an operation, said data transfer symbol indicating a data transfer between a memory for storing data and a data processing.

4. A script producing apparatus according to claim 1, wherein said plurality of GUIs includes both said turn GUI and said parallel GUI, and in addition a branch GUI for displaying a branch symbol on said image display screen in accordance with an operation, said branch symbol indicating that an execution order for a process branches.

5. A script producing program storage medium storing a script producing program comprising:
execution diagram producing means having a plurality of GUIs including both a turn GUI for displaying a predetermined turn symbol on an image display screen in accordance with an operation, said turn symbol indicating that a plurality of processes are sequentially executed, and also indicating turn of execution for the processes, and a parallel GUI for displaying a parallel symbol on said image display screen in accordance with an operation, said parallel symbol indicating that a plurality of processes are simultaneously executed, said execution diagram producing section producing an execution diagram representative of an execution order permitting a simultaneous execution for a plurality of processes in accordance with the plurality of GUIs; and
script producing means for producing, upon receipt of production of the execution diagram by said execution diagram producing means, a script representative of an execution order identical with the execution order represented by the execution diagram produced by said execution diagram producing means, wherein the execution order of the script is able to be recognized by a processing unit for executing a process.
